(19) United States
(12) Patent Application Publication
(10) Pub. No.: US 2007/0287070 A1
(43) Pub. Date: Dec. 13, 2007

(54) Electrode for Polymer Electrolyte Secondary Battery and Polymer Electrolyte Secondary Battery

(76) Inventors: Takefumi Okumura, Hitachi (JP); Shin Nishimura, Hitachi (JP); Norio Iwayasu, Hitachinaka (JP); Shoichi Yokoyama, Yokohama (JP); Tetsuya Itoh, Hitachi (JP); Takeshi Yabe, Kawasaki (JP); Kengo Ichimiya, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/572,335

(22) PCT Filed: Jul. 20, 2005
(86) PCT No.: PCT/JP05/13671

§ 371 Date: Jan. 19, 2007

(30) Foreign Application Priority Data
Jul. 20, 2004 (JP) 2004-211412

(51) Int. Cl. H01M 6/18; H01M 4/02

(52) U.S. Cl. 429/317; 429/217

(57) ABSTRACT

This invention provides a high-power secondary battery using a polymer electrolyte, a positive electrode, and a negative electrode. Such secondary battery comprises a positive electrode comprising a positive electrode active material that deintercalates and intercalates cations, a negative electrode comprising a negative electrode active material that intercalates and deintercalates cations deintercalated from the positive electrode, and an electrolytic layer comprising an ion conductive polymer that mediates between the positive electrode and the negative electrode and allows the cations to migrate, wherein the positive or negative electrode comprises an organic boron-containing compound as a binder component and the positive and/or negative electrode active material is treated with silane or aluminum.

### TECHNICAL FIELD

The present invention relates to a secondary battery, a positive electrode for a secondary battery, and a negative electrode for a secondary battery.

### BACKGROUND ART

Up to the present, liquid electrolytes have been used in electrochemical devices, such as batteries, capacitors, and sensors, because of their high ionic conductivity. However, liquid electrolytes were problematic in terms of, for example, the possibility of damage to equipment due to fluid leakage.

In order to overcome such drawbacks, secondary batteries using solid electrolytes, such as inorganic crystalline materials, inorganic glass, and organic polymers, have been proposed in recent years. Use of these solid electrolytes can result in less fluid leakage of carbonate solvents and less likelihood of electrolyte ignition than in cases where conventional liquid electrolytes using carbonate solvents are used. This results in enhanced device reliability and safety.

In general, solid electrolytes consisting of organic polymers (hereinafter referred to as “polymer electrolytes”) have excellent processability and moldability, electrolytes obtained therefrom have flexibility and bending workability, and the degree of freedom in designing devices to which solid electrolytes are to be applied can be increased. Thus, development thereof has been expected.

A technique has heretofore been known wherein, when polymer electrolytes are used for lithium secondary batteries, polymer electrolytes (ion conductive materials) are incorporated into the electrodes for batteries to produce batteries (see, for example, JP Patent Publication (Kokai) Nos. 9-50802 A (1997), 8-111233 A (1996), and 2001-319692 A).

JP Patent Publication (Kokai) No. 9-50802 A (1997) discloses a lithium battery comprising a positive electrode, a negative electrode, and a polymer electrolyte, wherein at least one of such electrodes is prepared by applying an electrolytic solution comprising photopolymerizable monomers, such as polyether acrylate or methacrylate, to a base film comprising polyethylene oxide (PEO) and active materials, causing the film to be penetrated by the electrolytic solution, and irradiating the film with light to polymerize photopolymerizable monomers. Ionic conductivity of PEO and that of the polymer of the photopolymerizable monomers are insufficient, resistance at the interface between active materials is not sufficiently reduced, and thus, the charge/discharge current density of the resulting battery cannot be increased. This makes the production of high-performance batteries impossible.

JP Patent Publication (Kokai) No. 8-111233 A (1996) discloses a secondary battery using a solid electrolyte comprising a positive electrode, wherein one or both ends of the polyether, polythioether, or polyacrylate main chain have been chemically bound to the surfaces of particles of positive electrode active materials. Due to insufficient ionic conductivity of polyether, polythioether, or polyacrylate chemically bound to the surfaces of the particles of active materials, the charge/discharge current density of the resulting battery cannot be increased. This makes the production of high-performance batteries impossible.

JP Patent Publication (Kokai) No. 2001-319692 A discloses a lithium-polymer battery comprising a positive electrode sheet composed of an electrolyte and fine particles of positive electrode active materials and electroconductive fine particles dispersed therein, wherein the electrolyte consists of polyethylene oxide having a number-average molecular weight of 400 to 20,000 and lithium salt dissolved in the polyethylene oxide. Due to poor binding strength of such polyethylene oxide and the difficulty of following the changes in active material volume caused by charge/discharge, the charge/discharge cycle characteristics are poor. Further, due to insufficient ionic conductivity, the charge/discharge current density of the resulting battery cannot be increased. This makes the production of high-performance batteries impossible.

### DISCLOSURE OF THE INVENTION

As mentioned above, due to insufficient ionic conductivity of the polymer electrolyte, ions are not smoothly intercalated or deintercalated between an active material and a polymer electrolyte. Also, a polymer electrolyte cannot follow expansion and shrinkage of an active material caused at the time of charge/discharge and thus flakes off. Accordingly, the path of intercalating or deintercalating ions is obstructed, which may result in lowering of charge/discharge capacity.

It is an object of the present invention to provide a secondary battery, a positive electrode for a secondary battery, and a negative electrode for a secondary battery, wherein the positive and/or negative electrode active materials of the battery comprising an ion conductive polymer as an electrolyte are subjected to treatment with silane, aluminum, or titanium, and an ion conductive material having higher ionic conductivity is introduced into the electrode, thereby facilitating cation intercalation and deintercalation and preventing decrease in charge/discharge capacity.

More specifically, the present invention is as follows.

(1) A secondary battery comprising a positive electrode comprising a positive electrode active material that deintercalates and intercalates cations, a negative electrode comprising a negative electrode active material that intercalates and deintercalates cations deintercalated from the positive electrode, and an electrolytic layer comprising an ion conductive polymer that mediates between the positive electrode and the negative electrode and allows the cations to migrate, wherein the positive and negative electrodes comprise an organic boron-containing compound as a binder component and the positive and/or negative electrode active material is treated with silane, aluminum, or titanium.

(2) A secondary battery comprising a positive electrode comprising a positive electrode active material that deintercalates and intercalates cations, a negative electrode comprising a negative electrode active material that intercalates and deintercalates cations deintercalated from the positive electrode, and an electrolytic layer comprising an ion conductive polymer that mediates between the positive electrode and the negative electrode and allows the cations to migrate, wherein the positive electrode comprises an organic boron-containing compound as a binder component and the positive and/or negative electrode active material is treated with silane, aluminum, or titanium.

(3) A secondary battery comprising a positive electrode comprising a positive electrode active material that deintercalates and intercalates cations, a negative electrode comprising a negative electrode active material that intercalates and deintercalates cations deintercalated from the positive electrode, and an electrolytic layer comprising an ion conductive polymer that mediates between the positive electrode and the negative electrode and allows the cations to migrate, wherein the negative electrode comprises an organic boron-containing compound as a binder component and the positive and/or negative electrode active material is treated with silane, aluminum, or titanium.

(4) The secondary battery, wherein the organic boron-containing compound is represented by formula (1): 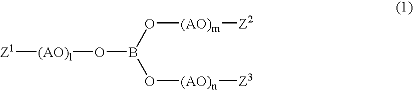
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

(5) The secondary battery, wherein the organic boron-containing compound is a polymer obtained by polymerizing the compound represented by formula (1).

(6) A positive electrode for a secondary battery using a polymer electrolyte,

wherein the positive electrode comprises an organic boron-containing compound as a binder component and the positive and/or negative electrode active material is treated with silane, aluminum, or titanium.

(7) A negative electrode for a secondary battery using a polymer electrolyte, wherein the negative electrode comprises an organic boron-containing compound as a binder component and the positive and/or negative electrode active material is treated with silane, aluminum, or titanium.

(8) A positive or negative electrode for a secondary battery, wherein the organic boron-containing compound is represented by formula (1): 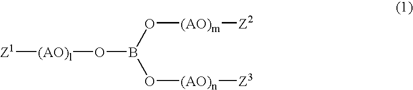
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

(9) A positive or negative electrode for a secondary battery, wherein the organic boron-containing compound is a polymer obtained by polymerizing the compound represented by formula (1).

(10) The secondary battery, wherein an electrolytic layer comprising an ion conductive polymer is polyethylene oxide, a polymer obtained by polymerizing a polyalkylene glycol (meth)acrylate compound, or a polymer obtained by polymerizing the organic boron-containing compound represented by formula (1) or a salt thereof.

### EFFECT OF THE INVENTION

The electrodes according to the present invention, when used for secondary battery where an ion conductive polymer is used as an electrolyte, can increase the charge/discharge current density and can also improve the charge/discharge characteristics, since the electrodes comprise surface-treated active materials which are covered with a highly ion conductive material comprising an organic boron-containing compound as a binder, whereby the paths for charging or discharging ions to or from the particles of active materials are sufficiently maintained and, in addition, smooth ion migration between an electrode and a polymer electrolyte is achieved.

This specification includes part or all of the contents as disclosed in the specification and/or drawings of Japanese Patent Application No. 2004-211412, which is a priority document of the present application.

### BRIEF DESCRIPTION OF THE DRAWINGS

FIG. 1 is a schematic perspective view showing the structure of the test battery that is used in the Examples.

### EXPLANATION OF NUMERALS

1 positive electrode
2 negative electrode
5 stainless steel terminal for the positive electrode
6 stainless steel terminal for the negative electrode
7 aluminum laminate film

### BEST MODE FOR CARRYING OUT THE INVENTION

Hereafter, the present invention is described in detail. The present invention relates to a secondary battery comprising a positive electrode comprising a positive electrode active material that deintercalates and intercalates cations, a negative electrode comprising a negative electrode active material that intercalates and deintercalates cations deintercalated from the positive electrode, and an electrolytic layer comprising an ion conductive polymer that mediates between the positive electrode and the negative electrode allows the cations to migrate, wherein the positive or negative electrode comprises an organic boron-containing compound as a binder component and the positive and/or negative electrode active material is treated with silane, aluminum, or titanium.

In the present invention, the organic boron-containing compound refers to an organic compound to which a boron atom has been covalently bound. Examples of such compounds include: borate compounds, such as trimethyl borate, triethyl borate, tripropyl borate, triisopropyl borate, tributyl borate, triisobutyl borate, tri-t-butyl borate, triphenyl borate, tritoluoyl borate, trimethoxyboroxin, and a product of esterification of a polyalkylene glycol derivative with boric acid; borane compounds, such as dimethylamine borane, trimethylamine borane, triethylamine borane, and morpholine borane; boronic acid compounds, such as propylboronic acid, isopropylboronic acid, butylboronic acid, t-butylboronic acid, and phenylboronic acid; boronic anhydrides, such as propylboronic anhydride, isopropylboronic anhydride, butylboronic anhydride, t-butylboronic anhydride, and phenylboronic anhydride; tetrahydroborates, such as tetramethylammonium borohydride, tetraethylammonium borohydride, tetra-n-butylammonium borohydride, and tetramethylammonium triacetoxyborohydride; and tetraphenylborates, such as tetra-n-butylammonium tetraphenylborate and tetraphenylphosphonium tetraphenylborate.

Examples of polyalkylene glycol derivatives include polyalkylene glycol, its terminal-alkylation product, and (meth)acrylic ester.

A borate compound is preferable from the viewpoint of good workability upon use thereof for secondary battery and electrochemical stability. A borate compound of a polyalkylene glycol derivative is more preferable in terms of ionic conductivity, and a compound represented by formula (1) is particularly preferable.

The compound represented by formula (1) according to the present invention is a borate compound of a polyalkylene glycol derivative. Polyalkylene glycol has an oxyalkylene group. Examples of oxyalkylene groups include oxyethylene, oxypropylene, oxybutylene, and oxytetramethylene groups. An oxyalkylene group preferably has 2 to 4 carbon atoms. In a molecule, a single oxyalkylene group may be present, two or more thereof may be present, or different types thereof may be present.

In formula (1), l, m, and n are each independently an average molar number of the oxyalkylene group(s) added, and they are each independently more than 1 and less than 100. They are preferably more than 1 and less than 4, and more preferably more than 2 and less than 4, since lithium ionic conductivity can be enhanced. The sum of l+m+n is more than 1 and less than 300. It is preferably more than 3 and less than 12, and more preferably more than 6 and less than 12, since ionic conductivity can be enhanced.

In formula (1), Z¹, Z², and Z³ each independently represent an organic group having an acryloyl or methacryloyl group or a hydrocarbon group having 1 to 10 carbon atoms.

An organic group having an acryloyl or methacryloyl group is defined as an organic group having acryloyl or methacryloyl group at its terminus. Examples thereof include: organic groups in which an acryloyl or methacryloyl group has been bound to a hydrocarbon group having 1 to 20 carbon atoms, such as acryloxyphenyl, methacryloxyphenyl, acryloxytoluoyl, methacryloxytoluoyl, acryloxyxylyl, methacryloxyxylyl, acyloxyethyl, methacryloxyethyl, acryloxypropyl, methacryloxypropyl, acryloxybutyl, methacryloxybutyl, acryloxyhexyl, methacryloxyhexyl, acryloxyoctyl, or methacryloxyoctyl; and organic groups in which an acryloyl or methacryloyl group has been bound to a glyceryl group, such as 1-acryloyl-3-methacryloylglyceryl, 1,3-dimethacryloylglyceryl, 1-oleyloyl-3-acryloylglyceryl, 1-oleoloyl-3-methacryloylglyceryl, 1-dodecynoyl-3-acryloylglyceryl, or 1-dodecynoyl-3-methacryloylglyceryl. An organic group having an acryloyl or methacryloyl group is preferably an acryloyl or methacryloyl group.

The aforementioned hydrocarbon group has 1 to 10 carbon atoms. Examples thereof include: aliphatic hydrocarbons, such as methyl, ethyl, propyl, butyl, pentyl, hexyl, heptyl, octyl, nonyl, and decyl groups; aromatic hydrocarbons, such as phenyl, toluoyl, and naphthyl groups; and alicyclic hydrocarbons, such as cyclopentyl, cyclohexyl, methylcyclohexyl, and dimethylcyclohexyl groups. A hydrocarbon group having 1 to 4 carbon atoms is preferable, and a methyl group having 1 carbon atom is particularly preferable.

Groups represented by Z¹ to Z³ may be one or more kinds of groups. When the groups represented by Z¹ to Z³ include organic groups having an acryloyl or methacryloyl group, such organic groups are preferably polymerized. In this case, ratio of the organic groups having an acryloyl or methacryloyl group to 3 groups of Z¹ to Z³ is no less than 0.3, preferably 0.4 and more preferably 0.6. When the ratio of organic groups having acryloyl or methacryloyl out of Z¹ to Z³ is no less that 0.3, electrodes can be produced without the use of other binder components. Further, when the ratio is no less than 0.6, sufficient mechanical strength can be realized.

When the compounds represented by formula (1) are polymerized, a compound in which all of Z¹ to Z³ are organic groups having an acryloyl or methacryloyl group may be mixed with a compound in which all of Z¹ to Z³ are hydrocarbon groups having 1 to 10 carbon atoms to bring the average number of the organic groups having an acryloyl or methacryloyl group represented by formula (1) to the level that satisfies the aforementioned conditions. When mixing a compound in which all of Z¹ to Z³ are organic groups having an acryloyl or methacryloyl group with a compound in which all of Z¹ to Z³ are hydrocarbon groups having 1 to 10 carbon atoms, transesterification of borate occurs among Z¹ to Z³, and thus the ratio of Z¹ to Z³ is averaged as a whole.

From the viewpoint of synthesizability and handleability, it is preferred that a compound in which all of Z¹ to Z³ are organic groups having an acryloyl or methacryloyl group and a compound in which all of Z¹ to Z³ are hydrocarbon groups having 1 to 10 carbon atoms are used and mixed with each other.

In the organic boron-containing compound represented by formula (1), mixing ratio of a compound in which all of Z¹ to Z³ are hydrocarbon groups having 1 to 10 carbon atoms to a compound in which all of Z¹ to Z³ are organic groups having an acryloyl or methacryloyl group is 0.1 to 9, preferably 0.5 to 4, more preferably 0.5 to 3, and particularly preferably 1 to 2.5, in terms of molar ratio of a compound of formula (1) in which all of Z¹ to Z³ are hydrocarbon groups having 1 to 10 carbon atoms to a compound of formula (1) in which all of Z¹ to Z³ are organic groups having an acryloyl or methacryloyl group. When such molar ratio becomes lower than 0.1, the resulting positive or negative electrode has poor flexibility, and a positive or negative electrode that can follow changes in active material volume at the time of charge or discharge cannot be obtained. When the molar ratio exceeds 9, the bonding strength is deteriorated, and production of a positive or negative electrode becomes difficult. When molar ratio of a compound of formula (1) in which all of Z¹ to Z³ are hydrocarbon groups having 1 to 10 carbon atoms to a compound of formula (1) in which all of Z¹ to Z³ are organic groups having an acryloyl or methacryloyl group is in the range from 4 to 9, though this cause decreased mechanical strength and difficulty in handling, molecular motion is activated to give improved ion conductivity and thus good charge-discharge behavior is achieved while its shape is kept.

The organic boron-containing compound represented by formula (1) can be produced in accordance with a conventional technique or via the method described below. A boron compound, such as boric acid, boric anhydride, or alkyl borate, is added to an oxyalkylene compound having a hydroxyl group, and the resulting mixture is subjected to vacuum conditions at 30° C. to 200° C. with aeration using a dry gas. Thus, esterification with boric acid can be performed. For example, an organic boron-containing compound can be generated via drying or devolatilization at a reaction temperature of 60° C. to 120° C. with aeration using an adequate amount of dry gas for 2 to 12 hours while agitating under reduced pressure of 1.33 to 66.7 kPa (10 to 500 mmHg). When the compound comprises an organic group represented by Z¹ to Z³ having an acryloyl or methacryloyl group, the reaction temperature is preferably set between 30° C. and 80° C. in order to protect such organic group.

An organic boron-containing compound is preferably produced using trialkyl borate, and particularly trimethyl borate, from the viewpoint of reduction in a water content or the like. When trialkyl borate is used, it is particularly preferable to produce an organic boron-containing compound by using 1.0 to 10 moles of trialkyl borate based on 3.0 moles of an oxyalkylene compound having a hydroxyl group and removing, by distillation, volatile components and an excess amount of trialkyl borate resulting from transesterification with boric acid.

When the organic boran-containing compound represented by formula (1) is polymerized, a polymer represented by formula (1) may be used alone, or the compound represented by formula (1) may be polymerized with another polymerizable compound. The homopolymer resulting from polymerization of the compound represented by formula (1) or a mixture of the aforementioned copolymer and another polymer compound may be used.

The positive or negative electrode may comprise the organic boran-containing compound according to the present invention in combination with a solution of another polymeric material or polymerizable compound in order to improve the bonding strength with an electrode active material and the flexibility of the resulting positive or negative electrode. When the organic boron-containing compound represented by formula (1) does not contain an organic group having an acryloyl or methacryloyl group, use of another polymerizable or polymer compound is particularly preferable from the viewpoint of maintaining bonding strength of the electrode active material.

Examples of such other polymerizable compounds include: (meth)acrylate compounds, such as methyl acrylate, ethyl acrylate, propyl acrylate, butyl acrylate, hexyl acrylate, octyl acrylate, 2-ethylhexyl acrylate, cyclohexyl acrylate, dodecyl acrylate, octadecyl acrylate, glycerol-1,3-diacrylate, trimethylolpropane triacrylate, pentaerythritol tetraacrylate, diglycerol tetraacrylate, dipentaerythritol hexaacrylate, methyl methacrylate, ethyl methacrylate, propyl methacrylate, butyl methacrylate, hexyl methacrylate, octyl methacrylate, 2-ethylhexyl methacrylate, cyclohexyl methacrylate, dodecyl methacrylate, octadecyl methacrylate, glycerol-1,3-dimethacrylate, trimethylolpropane trimethacrylate, pentaerythritol tetramethacrylate, diglycerol tetramethacrylate, and dipentaerythritol hexamethacrylate; polyalkylene glycol (meth)acrylate compounds, such as methoxypolyalkylene glycol acrylate, dodecyloxy polyalkylene glycol acrylate, octadecyloxy polyalkylene glycol acrylate, polyalkylene glycol diacrylate, glycerol tris(polyalkylene glycol)ether triacrylate, trimethylolpropane tris(polyalkylene glycol)ether triacrylate, pentaerythritol tetrakis(polyalkylene glycol)ether tetraacrylate, diglycerol tetrakis(polyalkylene glycol) tetraacrylate, methoxypolyalkylene glycol methacrylate, dodecyloxy polyalkylene glycol methacrylate, octadecyloxy polyalkylene glycol methacrylate, polyalkylene glycol dimethacrylate, glycerol tris(polyalkylene glycol)ether trimethacrylate, trimethylolpropane tris(polyalkylene glycol)ether trimethacrylate, pentaerythritol tetrakis(polyalkylene glycol)ether tetramethacrylate, and diglycerol tetrakis(polyalkylene glycol) tetramethacrylate; and glycidyl ether compounds, such as trimethylolpropane polyglycidyl ether, neopentyl glycol diglycidyl ether, bisphenol A glycidyl ether, glycidyl ether of a bisphenol A ethylene oxide adduct, and polyalkylene glycol diglydicyl ether.

Such other polymerizable compounds may be used alone or in combinations of two or more. Alternatively, one or more types of such compounds may be previously subjected to bulk polymerization, solution polymerization, emulsion polymerization, or other means to obtain a polymer, and a resulting polymer may be used. From the viewpoint of handleability, a (meth)acrylate or polyalkylene glycol (meth)acrylate compound is preferable. From the viewpoint of ionic conductivity, a polyalkylene glycol (meth)acrylate compound is further preferable.

Examples of such other polymer compounds include polyvinylidene fluoride (PVdF), a copolymer of hexafluoropropylene and acrylonitrile (PHFP-AN), styrene-butadiene rubber (SBR), carboxymethylcellulose (CMC), methylcellulose (MC), ethylcellulose (EC), polyvinyl alcohol (PVA), polyethylene oxide (PEO), a copolymer of polyethylene oxide and polypropylene oxide (PEO-PPO), and polymeric materials such as one or more polymers of the aforementioned polymerizable compounds. Among the kinds of aforementioned polyethylene oxide, a copolymer of polyethylene oxide and polypropylene oxide, and the other polymerizable compound, a polyalkylene glycol (meth)acrylate compound is preferable from the viewpoint of ionic conductivity.

Such other polymerizable or polymer compounds may be used alone or in combinations of two or more. When other polymerizable compounds are used, such polymerizable compounds may be previously subjected to homopolymerization via, for example, bulk polymerization, solution polymerization, or emulsion polymerization, or may be copolymerized with other polymerizable compounds.

In the present invention, treatment with silane, aluminum, or titanium refers to a procedure of treating an active material with a processing agent, such as a compound represented by formula (2) or a silicate compound represented by formula (3):
YMXp formula (2)

wherein M is selected from silicon, aluminum, and titanium; Y represents a group such as CH₂═CH—, CH₂═C(CH₃)COOC₃H₆—, 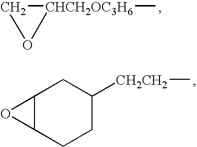
NH₂C₃H₆—, NH₂C₂H₄NHC₃H₆—, NH₂COCHC₃H₆—, CH₃COOC₂H₄NHC₂H₄NHC₃H₆—, NH₂C₂H₄NHC₂H₄NHC₃H₆—, SHC₃H₆—, ClC₃H₆—, CH₃—, C₂H₅—, C₂H₅OCONHC₃H₆—, OCNC₃H₆—, C₆H₅—, C₆H₅CH₂NHC₃H₆—, C₆H₅NHC₃H₆—, CH₃O—, C₂H₅O—, C₃H₇O—, iso-C₃H₇O—, C₄H₉O—, sec-C₄H₉O—, tert-C₄H₉O—, or C₄H₉CH(—C₂H₅)CH₂O—; X represents a group such as —OCH₃, —OC₂H₅, —OC₃H₇, —O-iso-C₃H₇, —OC₄H₉, —O-sec-C₄H₉, —O-tert-C₄H₉, —O—CH₂CH(—C₂H₅)C₄H₉, —OCOCH₃, —OC₂H₄OCH₃, —N(CH₃)₂, —Cl, or

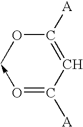

wherein A represents an alkyl group having 1 to 3 carbon atoms; and p is 3 when M represents silicon or titanium and 2 when it is aluminum; and
RO—[Si(—OR)₂—O-]_{q}R formula (3)

wherein R is a group selected from the group consisting of methyl, ethyl, propyl, isopropyl, butyl, isobutyl, and t-butyl; and q is a number between 2 and 30.

Specific examples of compounds represented by formulae (2) and (3) include vinyltriethoxysilane, vinyltrimethoxysilane, vinyltrichlorosilane, vinyltris(2-methoxyethoxy)silane, γ-methacryloxypropyltrimethoxysilane, γ-methacryloxypropyltriethoxysilane, γ-aminopropyltriethoxysilane, γ-aminopropyltrimethoxysilane, N-β-(aminoethyl)-γ-aminopropyltrimethoxysilane, N-β-(aminoethyl)-γ-aminopropyltriethoxysilane, γ-ureidopropyltriethoxysilane, γ-ureidopropyltrimethoxysilane, β-(3,4-epoxycyclohexyl)ethyltrimethoxysilane, β-(3,4-epoxycyclohexyl)ethyltriethoxysilane, γ-glycidoxypropyltrimethoxysilane, γ-glycidoxypropyltriethoxysilane, γ-mercaptopropyltrimethoxysilane, γ-mercaptopropyltriethoxysilane, γ-chloropropyltrimethoxysilane, γ-chloropropyltriethoxysilane, methyltriethoxysilane, methyltrimethoxysilane, phenyltriethoxysilane, phenyltrimethoxysilane, aluminum ethylate, aluminum isopropylate, aluminum diisopropylate mono-sec-butylate, aluminum-sec-butylate, aluminum ethyl acetoacetate diisopropylate, aluminum tris(ethyl acetoacetate), aluminum tris(acetyl acetonate), aluminum bis-ethyl aceto acetate mono acetyl acetonate, tetramethoxytitanium, tetraethoxytitanium, tetraisopropoxytitanium, tetra-n-butoxytitanium, diethoxy bis(ethyl acetoacetate)titanium, diethoxy bis(acetyl acetoacetate)titanium, diisopropoxy bis(ethyl acetoacetate)titanium, isopropoxy(2-ethyl-1,3-hexanedioate)titanium, and tetraacetylacetate titanium.

Among these compounds, for example, vinyltriethoxysilane, vinyltrimethoxysilane, vinyltris(2-methoxyethoxy)silane, γ-methacryloxypropyltrimethoxysilane, γ-methacryloxypropyltriethoxysilane, γ-aminopropyltriethoxysilane, γ-aminopropyltrimethoxysilane, N-β-(aminoethyl)-γ-aminopropyltrimethoxysilane, N-β-(aminoethyl)-γ-aminopropyltriethoxysilane, γ-ureidopropyltriethoxysilane, γ-ureidopropyttrimethoxysilane, β-(3,4-epoxycyclohexyl)ethyltrimethoxysilane, β-(3,4-epoxycyclohexyl)ethyltriethoxysilane, γ-glycidoxypropyltrimethoxysilane, γ-glycidoxypropyltriethoxysilane, aluminum ethylate, aluminum isopropylate, aluminum ethyl acetoacetate diisopropylate, aluminum tris(ethyl acetoacetate), aluminum tris(acetyl acetonate), aluminum bis-ethyl acetoacetate monoacetyl acetonate, tetramethoxytitanium, tetraethoxytitanium, tetraisopropoxytitanium, diethoxy bis(ethyl acetoacetate)titanium, diethoxy bis(acetyl acetoacetate)titanium, diisopropoxy bis(ethyl acetoacetate)titanium, and tetraacetylacetate titanium are preferably used.

Examples of more preferable compounds include vinyltriethoxysilane, vinyltrimethoxysilane, vinyltris(2-methoxyethoxy)silane, γ-methacryloxypropyltrimethoxysilane, γ-aminopropyltriethoxysilane, N-3-(aminoethyl)-γ-aminopropyltrimethoxysilane, γ-ureidopropyltriethoxysilane, β-(3,4-epoxycyclohexyl)ethyltrimethoxysilane, γ-glycidoxypropyltrimethoxysilane, aluminum ethylate, aluminum tris(ethyl acetoacetate), aluminum tris(acetyl acetonate), aluminum bis-ethyl acetoacetate monoacetyl acetonate, tetramethoxytitanium, tetraethoxytitanium, diethoxy bis(ethyl acetoacetate)titanium, diethoxy bis(acetyl acetoacetate)titanium, and tetraacetyl acetate titanium.

A mechanism that yields excellent effects with silane treatment is not evident. It may result from reduction in the amount of absorbed water on the surface or functional groups on the surface, which disadvantageously undergoes chemical reactions with lithium and stops affecting charge and discharge of a battery because of improved water resistance (lipophilic property). Treatment with aluminum or titanium using an organic titanium compound can produce similar effects and thus is useful.

Treatment with silane is preferable from the viewpoint of, for example, availability of starting material.

The amount of the processing agent that is used in the present invention is not particularly limited, and it is preferably determined by taking the specific surfaces (S) of carbon powder used into consideration. Specifically, it is deduced that a processing agent can coat an area of approximately 100 m² to 600 m² per gram thereof, although it depends on the type of the agent (S=(m²/g)). If the specific surface of the carbon powder used is A (m²/g), accordingly, the amount of the processing agent, i.e., A/S (g), is preferably employed a standard per gram of carbon powder. Even if the amount is insufficient to coat the entire surface of carbon powder with a processing agent, the irreversible volume can be significantly lowered. More specifically, the amount of the processing agent is preferably between 0.01 to 20 parts by weight, more preferably between 0.1 to 10 parts by weight, and particularly preferably between 0.5 and 5 parts by weight, based on 100 parts by weight of carbon powder to be used.

A method for treating an active material with a processing agent is not particularly limited. Examples of such method include a method wherein a compound represented by formula (2) is allowed to react with water, part or all thereof is subjected to hydrolysis, and the given amount of the resultant is added to and mixed with the active material powder, followed by drying in a heated oven. Another such example is a method wherein a silicate compound represented by formula (3) is dissolved in a low-molecular-weight alcohol, and the given amount of the resulting solution is added to and mixed with active material powder, followed by reaction and drying in a heated oven.

A positive electrode that reversibly intercalates and deintercalates lithium in the present invention may comprise: a layered compound such as lithium cobalt oxide (LiCoO₂), lithium nickel oxide (LiNiO₂), and LiMnₓNi_{y}CO_{z}O₂, which is an oxide composite comprising layered lithium manganese (LiMnO₂) or a plurality of transition metallic elements (x+y+z=1, 0≦y<1, 0≦z<1, 0≦x<1); a layered compound in which at least one kind of transition metal has been substituted; lithium manganese oxide (Li₁+ₓMn₂−ₓO₄, where X=0 to 0.33; Li₁+ₓMn₂−_{X}−_{Y}−M_{Y}O4, where M is at least one member selected from the group of metals consisting of Ni, Co, Cr, Cu, Fe, Al, and Mg, X═O to 0.33, and Y=0 to 1.0, and 2—X—Y>0; LiMnO₃, LiMn₂O₃, LiMnO₂, LiMn₂-ₓMₓO₂, where M is at least one member selected from the group of metals consisting of Co, Ni, Fe, Cr, Zn, and Ta, and X=0.0 to 0.1; Li₂Mn₃MO₈, where M is at least one member selected from the group of metals consisting of Fe, Co, Ni, Cu, and Zn); a copper-lithium oxide (Li₂CuO₂); an oxide of vanadium such as LiV₃O₈, LiFe₃O₄, V₂O₅, or Cu₂V₂O₇; a disulphide compound; or a mixture containing Fe₂(MoO₄)₃.

Materials used for the negative electrode that reversibly intercalates and deintercalates lithium in the present invention include: an easily graphitizable material obtained from natural graphite, petroleum coke, or coal pitch coke that has been subjected to heat treatment at high temperatures of 2500° C. or higher; mesophase carbon or amorphous carbon; carbon fiber; a metal that alloys with lithium; and a carbon particle carrying a metal on the surface thereof. Examples thereof include metals or alloys selected from the group consisting of lithium, aluminum, tin, silicon, indium, gallium, and magnesium. These metals or their oxides may be utilized for the negative electrode.

The binder component or the electrolytic layer of the positive or negative electrode according to the present invention may additionally comprise an electrolyte salt. Any electrolyte salt that is soluble in an electrolyte can be used without particular limitation, and the following compounds are preferable. Specific examples thereof include compounds comprising a metal cation and an anion selected from the group consisting of chlorine, bromine, iodine, perchlorate, thiocyanate, tetrafluoroborate, hexafluorophosphate, trifluoromethane-sulfonimide, bispentafluoroethane-sulfonimide, stearyl sulfonate, octyl sulfonate, dodecylbenzenesulfonate, naphthalenesulfonate, dodecylnaphthalenesulfonate, 7,7,8,8-tetracyano-p-quinodimethane, and lower aliphatic carboxylate ions. An example of a metal cation is Li.

A method for obtaining a positive or negative electrode comprising the organic boron-containing compound according to the present invention as a binder component is not particularly limited. As in the case of a general method for producing an electrode for a secondary battery, for example, an active material is mixed with a conducting agent and the organic boron-containing compound of the present invention or another polymerizable or polymer compound as a binder component to obtain a paste thereof, the paste is applied to metal foil as a charge collector, a solvent contained in the solution is removed via a hot-air dryer, and pressure is applied via a roll press. Thus, an electrode having active materials with partially or entirely coated surfaces can be obtained. When the binder component comprises an organic group having an acryloyl or methacryloyl group, such organic group is preferably polymerized via heating at the time of pressurization in order to facilitate cation migration. An organic group may be obtained by previous subjection to solution polymerization, emulsion polymerization, bulk polymerization, or other means to obtain a polymer, and the resulting polymer may be used to obtain the aforementioned paste.

When the organic boron-containing compound does not comprise an organic group having an acryloyl or methacryloyl group, such compound is preferably used in combination with other polymer materials or polymerizable compounds in order to retain electrode active material bonding strength. Even when the organic boron-containing compound comprises an organic group having an acryloyl or methacryloyl group, such organic compound may be used in combination with other polymerizable or polymer compounds in order to improve electrode active material bonding strength.

When the organic boron-containing compound of the present invention or another polymerizable compound has an organic group having an acryloyl or methacryloyl group, a polymerization initiator may or may not be used. Thermal polymerization utilizing a radical polymerization initiator is preferable from the viewpoint of workability and the speed of polymerization.

Examples of a radical polymerization initiator include: organic peroxides, such as t-butyl peroxypivalate, t-hexyl peroxypivalate, methyl ethyl ketone peroxide, cyclohexanone peroxide, 1,1-bis(t-butylperoxy)-3,3,5-trimethylcyclohexane, 2,2-bis(t-butylperoxy)octane, n-butyl-4,4-bis(t-butylperoxy)valerate, t-butyl hydroperoxide, cumene hydroperoxide, 2,5-dimethylhexane-2,5-dihydroperoxide, di-t-butyl peroxide, t-butyl cumyl peroxide, dicumyl peroxide, α,α′-bis(t-butylperoxy-m-isopropyl)benzene, 2,5-dimethyl-2,5-di(t-butylperoxy)hexane, benzoyl peroxide, and t-butylperoxyisopropyl carbonate; and azo compounds, such as 2,2′-azobisisobutyronitrile, 2,2′-azobis(2-methylbutyronitrile), 2,2′-azobis(4-methoxy-2,4-dimethylvaleronitrile), 2,2′-azobis(2,4-dimethylvaleronitrile), 1,1′-azobis(cyclohexane-1-carbonitrile), 2-(carbamoylazo)isobutyronitrile, 2-phenylazo-4-methoxy-2,4-dimethylvaleronitrile, 2,2′-azobis(2-methyl-N-phenylpropionamidine)dihydrochloride, 2,2′-azobis[N-(4-chlorophenyl)-2-methylpropionamidine]dihydrochloride, 2,2′-azobis[N-hydroxyphenyl]-2-methylpropionamidine]dihydrochloride, 2,2′-azobis[2-methyl-N-(phenylmethyl)propionamidine]dihydrochloride, 2,2′-azobis[2-methyl-N-(2-propenyl)propionamidine]dihydrochloride, 2,2′-azobis(2-methylpropionamidine)dihydrochloride, 2,2′-azobis[N-(2-hydroxyethyl)-2-methylpropionamidine]dihydrochloride, 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis {2-[1-(2-hydroxyethyl)-2-imidazolin-2-yl]propane}dihydrochloride, 2,2′-azobis[2-(2-imidazolin-2-yl)propane], 2,2′-azobis {2-methyl-N-[1,1-bis(hydroxymethyl)-2-hydroxyethyl]propionamide}, 2,2′-azobis {2-methyl-N-[1,1-bis(hydroxymethyl)ethyl]propionamide}, 2,2′-azobis[2-methyl-N-(2-hydroxyethyl)propionamide], 2,2′-azobis(2-methylpropionamide)dihydrate, 2,2′-azobis(2,4,4-trimethylpentane), 2,2′-azobis(2-methylpropane), dimethyl-2,2′-azobisisobutyrate, 4,4′-azobis(4-cyanovaleric acid), and 2,2′-azobis[2-(hydroxymethyl)propionitrile].

Production of a polymer utilizing a radical polymerization initiator can be carried out within a general temperature range and polymerization time. In order to avoid damaging the members used for an electrochemical device, use of a radical polymerization initiator with a 10 hour half-life decomposition temperature range of 30° C. to 90° C., which is the indicator of the decomposition temperature and the rate, is preferable. The term “10 hour half-life decomposition temperature” refers to the temperature required to bring the amount of undecomposed radical polymerization initiator to a half of the initial amount within 10 hours when the concentration of the initiator in a radical inactive solvent such as benzene is 0.01 mole/liter. In the present invention, the amount of the initiator to be incorporated is 0.01 to 10 mole percent, and preferably 0.1 to 5 mole percent, based on a mole of the polymerizable functional group.

The secondary battery of the present invention comprises an ion conductive polymer as an electrolyte, and any ion conductive polymer can be used without particular limitation. Examples thereof include: polyethers, such as polyethylene oxide (PEO), a copolymer of polyethylene oxide and polypropylene oxide (PEO-PPO), polypropylene oxide (PPO), and a copolymer of methoxy polyethylene glycol glycidyl ether and ethylene oxide; polythioethers, such as polyether urethane obtained via reactions between polyether and polyisocyanate, polyether ester obtained via reactions between polyether and a polybasic acid, polythiophene, polyoxysulfone, and poly(p-phenylene sulfide); polyetherketones, such as poly(oxybenzoin) and poly(oxyacetone); and a polymer obtained via polymerization of a polyalkylene glycol (meth)acrylate compound and a polymer obtained via polymerization of an organic boron-containing compound represented by formula (1) or a salt thereof.

An electrolyte is adequately selected in accordance with the relevant application or other conditions. Use of a polymer obtained via polymerization of a PEO or polyalkylene glycol (meth)acrylate compound or a polymer obtained via polymerization of an organic boron-containing compound represented by formula (1) or a salt thereof is preferable.

It is preferable to use PEO or PEO-PPO having a number-average molecular weight exceeding 20,000 since fluidity thereof can be inhibited in the temperature range where PEO or PEO-PPO is used for a secondary battery. It is more preferable to use PEO or PEO-PPO in combination with a polymer comprising as its structural unit an organic boron-containing compound represented by formula (1) or a salt thereof since ionic conductivity can be enhanced. A polymer obtained via polymerization of a polyalkylene glycol (meth)acrylate compound is preferably used in combination with a polymer obtained via polymerization of an organic boron-containing compound represented by formula (1) or a salt thereof since ionic conductivity can be enhanced.

The ion conductive polymer according to the present invention includes an organic boron-containing compound obtained via polymerization of a compound represented by formula (1). When a polymer obtained via polymerization of a boron-containing compound represented by formula (1) or a salt thereof is used for an electrolyte, such polymer can be used similarly as a binder of electrode materials. Concerning the following points, it is preferable to carry out the procedure as described.

When an organic boron-containing compound represented by formula (1) is contained as the ion conductive polymer according to the present invention, the average molar number of the oxyalkylene group(s) added in formula (1), i.e., l, m, and n, is more than 0 and less than 100. The average number is preferably more than 1 and less than 4, and more preferably more than 2 and less than 4, since lithium-ionic conductivity can be improved. The sum of l+m+n is more than 1 and less than 300, preferably more than 3 and less than 12, and more preferably more than 6 and less than 12, since this allows ionic conductivity to be improved.

In the organic boron-containing compound represented by formula (1), mixing ratio of a compound in which all of Z¹ to Z³ are hydrocarbon groups having 1 to 10 carbon atoms to a compound in which all of Z¹ to Z³ are organic groups having an acryloyl or methacryloyl group is 0.1 to 9, preferably 0.5 to 4, more preferably 0.5 to 3, and particularly preferably 1 to 2.5, in terms of molar ratio of a compound of formula (1) in which all of Z¹ to Z³ are hydrocarbon groups having 1 to 10 carbon atoms to a compound of formula (1) in which all of Z¹ to Z³ are organic groups having an acryloyl or methacryloyl group. When such molar ratio becomes less than 0.1, the resulting electrolytic film has poor flexibility, which may result in defects at the time of processing or lowered degree of freedom as the battery form. When the molar ratio exceeds 9, formation of a self-supported electrolytic film becomes difficult. When molar ratio of a compound of formula (1) in which all of Z¹ to Z³ are hydrocarbon groups having 1 to 10 carbon atoms to a compound of formula (1) in which all of Z¹ to Z³ are organic groups having an acryloyl or methacryloyl group is in the range from 4 to 9, though this cause decreased mechanical strength and difficulty in handling, molecular motion is activated to give improved ion conductivity and thus good charge-discharge behavior is achieved while its shape is kept.

When an organic boron-containing compound represented by formula (1) is contained as the ion conductive polymer according to the present invention, it can be obtained in the same manner as in the case of the aforementioned organic boron-containing compound.

When the aforementioned other polymer compound is used in combination, it may be previously dissolved or dispersed in a solvent. Examples of such solvent include water, methanol, ethanol, isopropanol, acetonitrile, N-methylpyrrolidinone, dimethylformamide, dimethylacetamide, dimethyl sulfoxide, ethylene carbonate, propylene carbonate, dimethyl carbonate, ethyl methyl carbonate, diethyl carbonate, γ-butyrolactone, ethylene glycol dimethyl ether, diethylene glycol dimethyl ether, triethylene glycol dimethyl ether, ethylene glycol monomethyl ether, and diethylene glycol monomethyl ether.

Examples of the aforementioned conducting agent include acetylene black, Ketjen black, graphite, metal powder, metal-coated resin powder, and metal-coated glass powder. Such material can be used alone or in the form of a mixture of two or more thereof.

The secondary battery according to the present invention can be obtained by, for example, inserting a polymer electrolyte between the positive electrode and the negative electrode obtained by coating on the metal foil. Alternatively, a precursor of a polymer electrolyte or a solution of a polar solvent is applied to the positive or negative electrode, cured, or removed with the aid of a solvent. Thus, a polymer electrolyte layer can be formed on the positive or negative electrode, and the electrodes are then stuck together to form the battery.

### EXAMPLES

The present invention is hereafter described in greater detail with reference to the examples, although the technical scope of the present invention is not limited thereto. Examples and Comparative Examples of the present invention are summarized in Table 1.

### Example 1

Vinyltriethoxysilane (trade name: A151, Nippon Unicar Company Limited) was first dispersed in pure water in an amount of 10% by weight thereof, the resulting dispersion was added to 100 parts by weight of lithium manganate powder (trade name: E10Z, Nikki Chemical Co., Ltd.) in an amount equivalent to 1 part by weight thereof, and the mixture was thoroughly mixed. Thereafter, the resultant was subjected to vacuum drying at 150° C. for 2 hours to obtain a silane-treated positive electrode active material.

Further, vinyltriethoxysilane (trade name: A151, Nippon Unicar Company Limited) was first dispersed in pure water in an amount of 10% by weight thereof, the resulting dispersion was added to 100 parts by weight of amorphous carbon (trade name: Carbotron PE, Kureha Chemical Industry Co., Ltd.) in an amount equivalent to 1 part by weight thereof, and the mixture was thoroughly mixed. Thereafter, the resultant was subjected to vacuum drying at 150° C. for 2 hours to obtain a silane-treated negative electrode active material.

A product of esterification of diethylene glycol monomethacrylate with boric acid (20 parts by weight), 108 parts by weight of a product of esterification of triethylene glycol monomethyl ether with boric acid, and 25.3 parts by weight of trifluoromethane sulfonimide lithium (Lin(CF₃SO₂)₂) as an electrolyte salt were mixed to prepare a solution. Further, 0.19 parts by weight of 2,2′-azobis(isobutyronitrile) was mixed and dissolved therein as a polymerization initiator to obtain a precursor of an ion conductive material. Subsequently, the aforementioned silane-treated lithium manganate powder (72 parts by weight) as a positive electrode active material, 8 parts by weight of amorphous carbon (trade name: Carbotron PE, Kureha Chemical Industry Co., Ltd.) as a conducting agent, and 20 parts by weight of the precursor of the ion conductive material were mixed to prepare a slurry mixture.

The slurry mixture was applied to aluminum foil with a thickness of 20 μm by the doctor blade method, and polymerizable components contained in the precursor of the ion conductive material were polymerized at 100° C. under a nitrogen atmosphere. The amount of the mixture applied was 400 g/m². The aluminum foil was pressed to bring the bulk density of the mixture to 2.5 g/cm³ and then cut into 1 cm×1 cm sections to produce positive electrodes.

The aforementioned silane-treated amorphous carbon (80 parts by weight) as a negative electrode active material was mixed with 20 parts by weight of the precursor of the ion conductive material to prepare a slurry solution. The slurry was applied to copper foil with a thickness of 20 μm by the doctor blade method, and polymerizable components contained in the precursor of the ion conductive material were polymerized at 100° C. under a nitrogen atmosphere. The amount of the mixture applied was 187 g/m². The copper foil was pressed to bring the bulk density of the mixture to 1.0 g/cm³ and then cut into 1 cm×1 cm sections to produce negative electrodes.

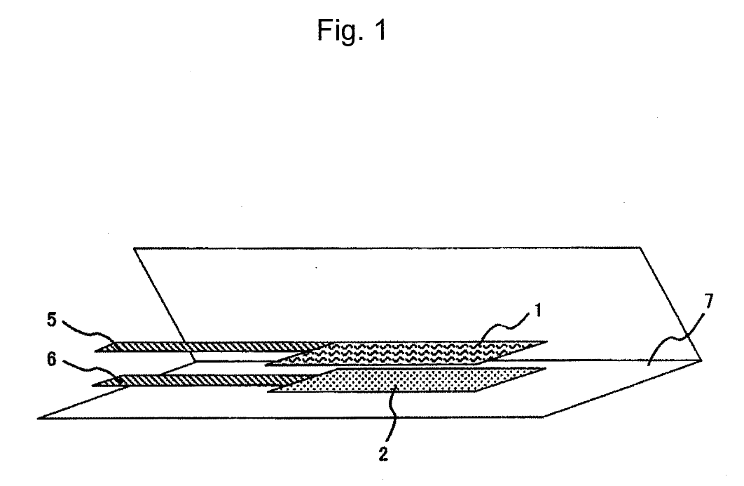

Subsequently, the precursor of the ion conductive material was cast on the positive and negative electrodes prepared by the aforementioned method, and the cast electrodes were cured at 100° C. under a nitrogen atmosphere to produce polymer electrolytes on the positive and negative electrodes. The positive and negative electrodes were then laid one upon the other and were retained at 80° C. for 6 hours under a load of 0.1 MPa to bind them together. As shown in FIG. 1, stainless steel terminals 5 and 6 were then attached to the positive electrode 1 and the negative electrode 2, respectively, and the electrodes were then inserted into a pouched aluminum laminate film 7 to prepare a secondary battery. The resulting secondary battery was subjected to evaluation in the following manner.

<Evaluation>

The produced positive electrode was inserted between two stainless steel (SUS304) terminals, and an alternating voltage of 10 mV was applied to measure the electronic resistance. A charge/discharge operation was performed using a charger/discharger (TOSCAT3000, Toyo System Co., Ltd.) at 25° C. with a current density of 0.2 mA/cm². Constant current charge operation was performed up to 4.2 V, whereupon constant voltage charge operation was performed for 12 hours. Further, constant current discharge operation was performed until the voltage reached a discharge termination voltage of 3.5 V. The capacity that was achieved by the initial discharge was determined to be the initial discharge capacity. A cycle of charging and discharging under the above conditions was repeated until the capacity decreased to 70% or less of the initial discharge capacity, and the number of times the cycle was repeated was designated as a cycle characteristics. Also, constant-current charge operation was performed with a current density of 1 mA/cm² up to 4.2 V, whereupon constant-voltage charge operation was performed for 12 hours. Further, constant-current discharge operation was performed until the voltage reached a discharge termination voltage of 3.5 V. The resulting capacity was compared with the initial cycle capacity obtained in the aforementioned charge/discharge cycle, and the ratio was designated as a high-speed discharge characteristics. The results of evaluation of the initial discharge capacity, the cycle characteristics, and the high-speed discharge characteristics are shown in Table 1.

### Example 2

Evaluation was carried out in a manner identical to that of Example 1 except that 8.27 parts by weight of LiBF₄ was used instead of 25.3 parts by weight of LiN(CF₃SO₂)₂ as the electrolyte salt. The results are shown in Table 1.

### Example 3

Evaluation was carried out in a manner identical to that of Example 1 except that 34.1 parts by weight of LiN(C₂F₅SO₂)₂ was used instead of 25.3 parts by weight of LiN(CF₃SO₂)₂ as the electrolyte salt. The results are shown in Table 1.

### Example 4

Methyl silicate oligomer (trade name: MKC silicate MS51, Mitsubishi Chemical Corporation) was first dispersed in methanol in an amount of 10% by weight thereof, the resulting dispersion was added to 50 parts by weight of lithium manganate powder (trade name: E10Z, Nikki Chemical Co., Ltd.) in an amount equivalent to 50 parts by weight thereof, and the mixture was thoroughly mixed. Thereafter, lithium manganate powder was separated via filtration, followed by vacuum drying at 150° C. for 1 hour to obtain a silicate-treated positive electrode active material.

Further, methyl silicate oligomer (trade name: MKC silicate MS51, Mitsubishi Chemical Corporation) was first dispersed in methanol in an amount of 10% by weight thereof, the resulting dispersion was added to 50 parts by weight of amorphous carbon (trade name: Carbotron PE, Kureha Chemical Industry Co., Ltd.) in an amount equivalent to 50 parts by weight thereof, and the mixture was thoroughly mixed. Thereafter, amorphous carbon was separated via filtration, followed by vacuum drying at 150° C. for 1 hour to obtain a silicate-treated negative electrode active material.

A product of esterification of diethylene glycol monomethacrylate with boric acid (20 parts by weight), 108 parts by weight of a product of esterification of triethylene glycol monomethyl ether with boric acid, and 25.3 parts by weight of trifluoromethane sulfonimide lithium (Lin(CF₃SO₂)₂) as an electrolyte salt were mixed to prepare a solution. Further, 0.19 parts by weight of 2,2′-azobisisobutyronitrile was mixed and dissolved therein as a polymerization initiator to obtain a precursor of an ion conductive material. Subsequently, a copolymer of polyethylene oxide and polypropylene oxide having a molecular weight of 1,000,000 (trade name: Alkox EP-20×, Meisei Chemical Works, Ltd.) was dissolved in γ-butyrolactone to obtain a 30 g/liter polymer solution thereof. The aforementioned silicate-treated lithium manganate powder (72 parts by weight) as a positive electrode active material, 8 parts by weight of amorphous carbon (trade name: Carbotron PE, Kureha Chemical Industry Co., Ltd.) as a conducting agent, and 20 parts by weight of the precursor of the ion conductive material were mixed. Further, 50 parts by weight of the polymer solution was added thereto to prepare a slurry solution. The slurry was applied to aluminum foil with a thickness of 20 μm by the doctor blade method, the aluminum foil was dried at 100° C. under a nitrogen atmosphere, and polymerizable components contained in the precursor of the ion conductive material were polymerized. The amount of the mixture applied was 400 g/m². The aluminum foil was pressed to bring the bulk density of the mixture to 2.5 g/cm³ and then cut into 1 cm×1 cm sections to produce positive electrodes.

The aforementioned silicate-treated amorphous carbon (80 parts by weight) as a negative electrode active material and 20 parts by weight of the precursor of the ion conductive material were mixed. Further, 50 parts by weight of the polymer solution was added thereto to prepare a slurry solution. The slurry was applied to copper foil with a thickness of 20 μm by the doctor blade method, the copper foil was dried at 100° C. under a nitrogen atmosphere, and polymerizable components contained in the precursor of the ion conductive material were polymerized. The amount of the mixture applied was 187 g/m². The copper foil was pressed to bring the bulk density of the mixture to 1.0 g/cm³ and then cut into 1 cm×1 cm sections to produce negative electrodes.

Further, a copolymer of polyethylene oxide and polypropylene oxide having a molecular weight of 1,000,000 (trade name: Alkox EP-20×, Meisei Chemical Works, Ltd.) and LiN(CF₃SO₂)₂ (adjusted to 1/32 of the total molar number of the ether oxygen in such copolymer) were mixed and dissolved in acetonitrile to prepare a solution. The resulting solution was cast on the positive and negative electrodes prepared by the aforementioned method, and the cast electrodes were subjected to vacuum drying at 80° C. for 12 hours to produce polymer electrolytes on the positive and negative electrodes. The positive and negative electrodes were then laid one upon the other and were retained at 80° C. for 6 hours under a load of 0.1 MPa to bind them together. As shown in FIG. 1, stainless steel terminals 5 and 6 were then attached to the positive electrode 1 and the negative electrode 2, respectively, and the electrodes were then inserted into a pouched aluminum laminate film 7 to prepare a secondary battery. The resulting secondary battery was subjected to evaluation in the same manner as in Example 1.

### Example 5

Evaluation was carried out in a manner identical to that of Example 4 except that 8.27 parts by weight of LiBF₄ was used instead of 25.3 parts by weight of LiN(CF₃SO₂)₂ as the electrolyte salt. The results are shown in Table 1.

### Example 6

Evaluation was carried out in a manner identical to that of Example 4 except that 34.1 parts by weight of LiN(C₂F₅SO₂)₂ was used instead of 25.3 parts by weight of LiN(CF₃SO₂)₂ as the electrolyte salt. The results are shown in Table 1.

### Example 7

Aluminum ethylate (trade name: Aluminum ethoxide, Kawaken Fine Chemicals Co., Ltd.) was first dispersed in pure water in an amount of 10% by weight thereof, the resulting dispersion was added to 100 parts by weight of lithium manganate powder (trade name: E10Z, Nikki Chemical Co., Ltd.) in an amount equivalent to 1 part by weight thereof, and the mixture was thoroughly mixed. Thereafter, the resultant was subjected to vacuum drying at 150° C. for 2 hours to obtain an aluminum-treated positive electrode active material.

Further, aluminum ethylate (trade name: Aluminum ethoxide, Kawaken Fine Chemicals Co., Ltd.) was first dispersed in pure water in an amount of 10% by weight thereof, the resulting dispersion was added to 100 parts by weight of amorphous carbon (trade name: Carbotron PE, Kureha Chemical Industry Co., Ltd.) in an amount equivalent to 1 part by weight thereof, and the mixture was thoroughly mixed. Thereafter, the resultant was subjected to vacuum drying at 150° C. for 2 hours to obtain an aluminum-treated negative electrode active material.

A product of esterification of diethylene glycol monomethacrylate with boric acid (20 parts by weight), 108 parts by weight of a product of esterification of triethylene glycol monomethyl ether with boric acid, and 25.3 parts by weight of trifluoromethane sulfonimide lithium (Lin(CF₃SO₂)₂) as an electrolyte salt were mixed to prepare a solution. Further, 0.19 parts by weight of 2,2′-azobisisobutyronitrile was mixed and dissolved therein as a polymerization initiator to obtain a precursor of an ion conductive material. Subsequently, a copolymer of polyethylene oxide and polypropylene oxide having a molecular weight of 1,000,000 (trade name: Alkox EP-20×, Meisei Chemical Works, Ltd.) was dissolved in γ-butyrolactone to obtain a 30 g/liter polymer solution thereof. The aforementioned aluminum-treated lithium manganate powder (72 parts by weight) as a positive electrode active material, 8 parts by weight of amorphous carbon (trade name: Carbotron PE, Kureha Chemical Industry Co., Ltd.) as a conducting agent, and 20 parts by weight of the precursor of the ion conductive material were mixed. Further, 50 parts by weight of the polymer solution was added thereto to prepare a slurry solution. The slurry was applied to aluminum foil with a thickness of 20 μm by the doctor blade method, the aluminum foil was dried at 100° C. under a nitrogen atmosphere, and polymerizable components contained in the precursor of the ion conductive material were polymerized. The amount of the mixture applied was 400 g/m². The aluminum foil was pressed to bring the bulk density of the mixture to 2.5 g/cm³ and then cut into 1 cm×1 cm sections to produce positive electrodes.

The aforementioned aluminum-treated amorphous carbon (80 parts by weight) as a negative electrode active material was mixed with 20 parts by weight of the precursor of the ion conductive material. Further, 50 parts by weight of the polymer solution was added thereto to prepare a slurry solution. The slurry was applied to copper foil with a thickness of 20 μm by the doctor blade method, the copper foil was dried at 100° C. under a nitrogen atmosphere, and polymerizable components contained in the precursor of the ion conductive material were polymerized. The amount of the mixture applied was 187 g/m². The copper foil was pressed to bring the bulk density of the mixture to 1.0 g/cm³ and then cut into 1 cm×1 cm sections to produce negative electrodes.

Further, a copolymer of polyethylene oxide and polypropylene oxide having a molecular weight of 1,000,000 (trade name: Alkox EP-20×, Meisei Chemical Works, Ltd.) and LiN(CF₃SO₂)₂ (adjusted to 1/32 of the total molar number of the ether oxygen in such copolymer) were mixed and dissolved in acetonitrile to prepare a solution. The resulting solution was cast on the positive and negative electrodes prepared by the aforementioned method, and the cast electrodes were subjected to vacuum drying at 80° C. for 12 hours to produce polymer electrolytes on the positive and negative electrodes. The positive and negative electrodes were then laid one upon the other and were retained at 80° C. for 6 hours under a load of 0.1 MPa to bind them together. As shown in FIG. 1, stainless steel terminals 5 and 6 were then attached to the positive electrode 1 and the negative electrode 2, respectively, and the electrodes were then inserted into a pouched aluminum laminate film 7 to prepare a secondary battery. The resulting secondary battery was subjected to evaluation in the same manner as in Example 1.

### Example 8

Evaluation was carried out in a manner identical to that of Example 7 except that 8.27 parts by weight of LiBF₄ was used instead of 25.3 parts by weight of LiN(CF₃SO₂)₂ as the electrolyte salt. The results are shown in Table 1.

### Example 9

Evaluation was carried out in a manner identical to that of Example 7 except that 34.1 parts by weight of LiN(C₂F₅SO₂)₂ was used instead of 25.3 parts by weight of LiN(CF₃SO₂)₂ as the electrolyte salt. The results are shown in Table 1.

### Example 10

Tetramethoxytitanium (Kojundo Chemical Laboratory Co., Ltd.) was first dispersed in pure water in an amount of 10% by weight thereof, the resulting dispersion was added to 100 parts by weight of lithium manganate powder (trade name: E10Z, Nikki Chemical Co., Ltd.) in an amount equivalent to 1 part by weight thereof, and the mixture was thoroughly mixed. Thereafter, the resultant was subjected to vacuum drying at 150° C. for 2 hours to obtain a titanium-treated positive electrode active material.

Further, tetramethoxytitanium (Kojundo Chemical Laboratory Co., Ltd.) was first dispersed in pure water in an amount of 10% by weight thereof, the resulting dispersion was added to 100 parts by weight of amorphous carbon (trade name: Carbotron PE, Kureha Chemical Industry Co., Ltd.) in an amount equivalent to 1 part by weight thereof, and the mixture was thoroughly mixed. Thereafter, the resultant was subjected to vacuum drying at 150° C. for 2 hours to obtain a titanium-treated negative electrode active material.

A product of esterification of diethylene glycol monomethacrylate with boric acid (20 parts by weight), 108 parts by weight of a product of esterification of triethylene glycol monomethyl ether with boric acid, and 25.3 parts by weight of trifluoromethane sulfonimide lithium (Lin(CF₃SO₂)₂) as an electrolyte salt were mixed to prepare a solution. Further, 0.19 parts by weight of 2,2′-azobisisobutyronitrile was mixed and dissolved therein as a polymerization initiator to obtain a precursor of an ion conductive material. Subsequently, a copolymer of polyethylene oxide and polypropylene oxide having a molecular weight of 1,000,000 (trade name: Alkox EP-20×, Meisei Chemical Works, Ltd.) was dissolved in γ-butyrolactone to obtain a 30 g/liter polymer solution thereof. The aforementioned titanium-treated lithium manganate powder (72 parts by weight) as a positive electrode active material, 8 parts by weight of amorphous carbon (trade name: Carbotron PE, Kureha Chemical Industry Co., Ltd.) as a conducting agent, and 20 parts by weight of the precursor of the ion conductive material were mixed. Further, 50 parts by weight of the polymer solution was added thereto to prepare a slurry solution. The slurry was applied to aluminum foil with a thickness of 20 μm by the doctor blade method, the aluminum foil was dried at 100° C. under a nitrogen atmosphere, and polymerizable components contained in the precursor of the ion conductive material were polymerized. The amount of the mixture applied was 400 g/m². The aluminum foil was pressed to bring the bulk density of the mixture to 2.5 g/cm³ and then cut into 1 cm×1 cm sections to produce positive electrodes.

The aforementioned titanium-treated amorphous carbon (80 parts by weight) as a negative electrode active material was mixed with 20 parts by weight of the precursor of the ion conductive material. Further, 50 parts by weight of the polymer solution was added thereto to prepare a slurry solution. The slurry was applied to copper foil with a thickness of 20 μm by the doctor blade method, the copper foil was dried at 100° C. under a nitrogen atmosphere, and polymerizable components contained in the precursor of the ion conductive material were polymerized. The amount of the mixture applied was 187 g/m². The copper foil was pressed to bring the bulk density of the mixture to 1.0 g/cm³ and then cut into 1 cm×1 cm sections to produce negative electrodes.

Further, a copolymer of polyethylene oxide and polypropylene oxide having a molecular weight of 1,000,000 (trade name: Alkox EP-20×, Meisei Chemical Works, Ltd.) and LiN(CF₃SO₂)₂ (adjusted to 1/32 of the total molar number of the ether oxygen in such copolymer) were mixed and dissolved in acetonitrile to prepare a solution. The resulting solution was cast on the positive and negative electrodes prepared by the aforementioned method, and the cast electrodes were subjected to vacuum drying at 80° C. for 12 hours to produce polymer electrolytes on the positive and negative electrodes. The positive and negative electrodes were then laid one upon the other and were retained at 80° C. for 6 hours under a load of 0.1 MPa to bind them together. As shown in FIG. 1, stainless steel terminals 5 and 6 were then attached to the positive electrode 1 and the negative electrode 2, respectively, and the electrodes were then inserted into a pouched aluminum laminate film 7 to prepare a secondary battery. The resulting secondary battery was subjected to evaluation in the same manner as in Example 1.

### Example 11

Evaluation was carried out in a manner identical to that of Example 10 except that 8.27 parts by weight of LiBF₄ was used instead of 25.3 parts by weight of LiN(CF₃SO₂)₂ as the electrolyte salt. The results are shown in Table 1.

### Example 12

Evaluation was carried out in a manner identical to that of Example 10 except that 34.1 parts by weight of LiN(C₂F₅SO₂)₂ was used instead of 25.3 parts by weight of LiN(CF₃SO₂)₂ as the electrolyte salt. The results are shown in Table 1.

### Comparative Example 1

Polyethylene oxide having a molecular weight of 700,000 (trade name: Alkox E-45, Meisei Chemical Works, Ltd.) and LiN(CF₃SO₂)₂ (adjusted to 1/32 of the total molar number of the ether oxygen atom in a copolymer of polyethylene oxide and polypropylene oxide) were dissolved in γ-butyrolactone to prepare a 30 g/liter polymer solution thereof. Lithium manganate powder (72 parts by weight, trade name: E10Z, Nikki Chemical Co., Ltd.) as a positive electrode active material, 8 parts by weight of amorphous carbon (trade name: Carbotron PE, Kureha Chemical Industry Co., Ltd.) as a conducting agent, and the aforementioned polymer solution were mixed to bring a polyethylene oxide content to 20 parts by weight to prepare a slurry solution. The slurry was applied to aluminum foil with a thickness of 20 μm by the doctor blade method, and the aluminum foil was dried. The amount of the mixture applied was 400 g/m². The aluminum foil was pressed to bring the bulk density of the mixture to 2.5 g/cm³ and then cut into 1 cm×1 cm sections to produce positive electrodes.

Amorphous carbon (80 parts by weight, trade name: Carbotron PE, Kureha Chemical Industry Co., Ltd.) as a negative electrode active material was mixed with the aforementioned polymer solution to prepare a slurry solution in a manner such that a polyethylene oxide content was brought to 20 parts by weight therein. The slurry was applied to copper foil with a thickness of 20 μm by the doctor blade method, and the copper foil was dried. The amount of the mixture applied was 187 g/m². The copper foil was pressed to bring the bulk density of the mixture to 1.0 g/cm³ and then cut into 1 cm×1 cm sections to produce negative electrodes.

Further, Polyethylene oxide having a molecular weight of 700,000 (trade name: Alkox E-45, Meisei Chemical Works, Ltd.) and LiN(CF₃SO₂)₂ (adjusted to 1/32 of the total molar number of the ether oxygen atom in a copolymer of polyethylene oxide and polypropylene oxide) were mixed and dissolved in acetonitrile to prepare a solution. The resulting solution was cast on the positive and negative electrodes prepared by the aforementioned method, and the cast electrodes were subjected to vacuum drying at 80° C. for 12 hours to produce polymer electrolytes on the positive and negative electrodes. The positive and negative electrodes were then laid one upon the other and were retained at 80° C. for 6 hours under a load of 0.1 MPa to bind them together. As shown in FIG. 1, stainless steel terminals 5 and 6 were then attached to the positive electrode 1 and the negative electrode 2, respectively, and the electrodes were then inserted into a pouched aluminum laminate film 7 to prepare a secondary battery. The resulting secondary battery was subjected to evaluation in the same manner as in Example 1.

TABLE 1

| | | | | | Electronic | Initial | Cycle | |
|---|---|---|---|---|---|---|---|---|
| | | | | | resistance of | discharge | characteristic, | High-speed |
| | | Electrolyte salt | | | positive | capacity, | number | discharge |
| Ex. | Treating agent | LiN(CF₃SO₂)₂ | LiBF₄ | LiN(C₂F₅SO₂)₂ | electrode, Ω | mAh | of times | characteristics, % |
| 1 | Vinyltriethoxysilane | ◯ | — | — | 3.0 | 2.6 | 80 | 25 |
| 2 | ↑ | — | ◯ | — | 2.5 | 2.6 | 60 | 25 |
| 3 | ↑ | — | — | ◯ | 2.8 | 2.6 | 70 | 30 |
| 4 | Silicate | ◯ | — | — | 2.9 | 2.6 | 70 | 30 |
| 5 | ↑ | — | ◯ | — | 2.4 | 2.6 | 80 | 30 |
| 6 | ↑ | — | — | ◯ | 2.7 | 2.6 | 80 | 30 |
| 7 | Aluminum ethylate | ◯ | — | — | 2.8 | 2.5 | 70 | 30 |
| 8 | ↑ | — | ◯ | — | 2.3 | 2.5 | 70 | 30 |
| 9 | ↑ | — | — | ◯ | 2.6 | 2.5 | 70 | 30 |
| 10 | Tetramethoxytitanium | ◯ | — | — | 2.8 | 2.5 | 60 | 25 |
| 11 | ↑ | — | ◯ | — | 2.6 | 2.5 | 70 | 30 |
| 12 | ↑ | — | — | ◯ | 2.7 | 2.6 | 60 | 30 |
| Comp. | — | — | — | ◯ | 45.0 | 0.7 | 15 | 10 |
| Ex. 1 | | | | | | | | |

1. A secondary battery comprising a positive electrode comprising a positive electrode active material that deintercalates and intercalates cations, a negative electrode comprising a negative electrode active material that intercalates and deintercalates cations deintercalated from the positive electrode, and an electrolytic layer comprising an ion conductive polymer that mediates between the positive electrode and the negative electrode and allows the cations to migrate, wherein the positive and negative electrodes comprise an organic boron-containing compound as a binder component and at least one of the positive electrode active material or the negative electrode active material is treated with silane, aluminum, or titanium.

2. A secondary battery comprising a positive electrode comprising a positive electrode active material that deintercalates and intercalates cations, a negative electrode comprising a negative electrode active material that intercalates and deintercalates cations deintercalated from the positive electrode, and an electrolytic layer comprising an ion conductive polymer that mediates between the positive electrode and the negative electrode and allows the cations to migrate, wherein the positive electrode comprises an organic boron-containing compound as a binder component and at least one of the positive electrode active material or the negative electrode active material is treated with silane, aluminum, or titanium.

3. A secondary battery comprising a positive electrode comprising a positive electrode active material that deintercalates and intercalates cations, a negative electrode comprising a negative electrode active material that intercalates and deintercalates cations deintercalated from the positive electrode, and an electrolytic layer comprising an ion conductive polymer that mediates between the positive electrode and the negative electrode and allows the cations to migrate, wherein the negative electrode comprises an organic boron-containing compound as a binder component and at least one of the positive electrode active material or the negative electrode active material is treated with silane, aluminum, or titanium.

4. The secondary battery according to claim 1, wherein the organic boron-containing compound is represented by formula (1): 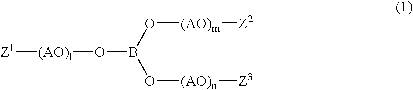
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

5. The secondary battery according to claim 1, wherein the organic boron-containing compound is a polymer obtained by polymerizing the compound represented by formula (1): 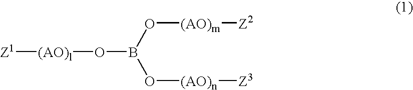
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

6. A positive electrode for a secondary battery having an electrolytic layer comprising an ion conductive polymer, wherein the positive electrode comprising a positive electrode active material comprises an organic boron-containing compound as a binder component and the positive electrode active material is treated with silane, aluminum, or titanium.

7. A negative electrode for a secondary battery having an electrolytic layer comprising an ion conductive polymer, wherein the negative electrode comprising a negative electrode active material comprises an organic boron-containing compound as a binder component and the negative electrode active material is treated with silane, aluminum, or titanium.

8. The positive electrode for a secondary battery according to claim 6, wherein the organic boron-containing compound is represented by formula (1): 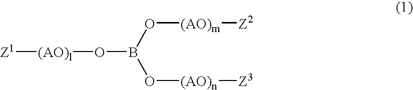
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

9. The positive electrode for a secondary battery according to claim 6, wherein the organic boron-containing compound is a polymer obtained by polymerizing the compound represented by formula (1): 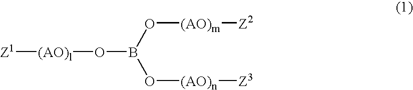
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

10. The secondary battery according to claim 1, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

11. The secondary battery according to claim 4, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

12. The secondary battery according to claim 5, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

13. The secondary battery according to claim 2, wherein the organic boron-containing compound is represented by formula (1): 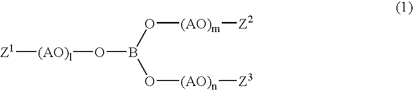
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

14. The secondary battery according to claim 2, wherein the organic boron-containing compound is a polymer obtained by polymerizing the compound represented by formula (1): 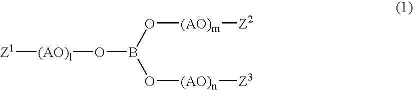
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

15. The secondary battery according to claim 2, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

16. The secondary battery according to claim 13, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

17. The secondary battery according to claim 14, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

18. The secondary battery according to claim 3, wherein the organic boron-containing compound is represented by formula (1): 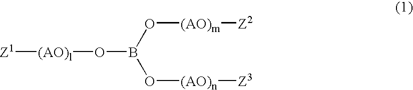
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

19. The secondary battery according to claim 3, wherein the organic boron-containing compound is a polymer obtained by polymerizing the compound represented by formula (1): 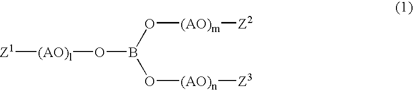
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

20. The secondary battery according to claim 3, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

21. The secondary battery according to claim 18, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

22. The secondary battery according to claim 19, wherein an electrolytic layer comprising an ion conductive polymer is polyethylene oxide, a copolymer of polyethylene oxide and polypropylene oxide, a polymer obtained by polymerizing a polyalkylene glycol (meth)acrylate compound, or a polymer obtained by polymerizing the organic boron-containing compound represented by formula (1) or a salt thereof.

23. The negative electrode for a secondary battery according to claim 7, wherein the organic boron-containing compound is represented by formula (1): 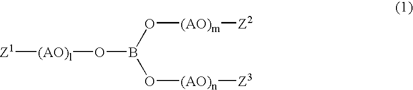
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.

24. The negative electrode for a secondary battery according to claim 6, wherein the organic boron-containing compound is a polymer obtained by polymerizing the compound represented by formula (1): 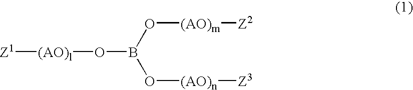
wherein B represents a boron atom; Z¹, Z², and Z³ each independently represent an organic group having an acryloyl or methacryloyl group or a hydrocarbon group having 1 to 10 carbon atoms; AO represents one or more types of oxyalkylene group having 2 to 6 carbon atoms; and l, m, and n are each independently an average molar number of the oxyalkylene group(s) added, provided that such number is more than 0 and less than 100 and that the sum of l+m+n is at least 1.
